(19) United States
(12) Patent Application Publication
(10) Pub. No.: US 2018/0250801 A1
(43) Pub. Date: Sep. 6, 2018

(54) SETTING TOOL

(71) Applicant: Hilti Aktiengesellschaft, Schaan (LI)

(72) Inventors: Roland FOSER, Schaan (LI); Tanja STEINBERG, Buchs (CH); Gerald SCHREIBER, Feldkirch (AT)

(21) Appl. No.: 15/754,761

(22) PCT Filed: Aug. 16, 2016
(86) PCT No.: PCT/EP2016/069411

§ 371 Date: Feb. 23, 2018

(30) Foreign Application Priority Data
Aug. 25, 2015 (EP) 15182262.4

(51) Int. Cl. B25B 31/00; B23B 51/02; B23B 51/08

(52) U.S. Cl. CPC B25B 31/00; B25D 2250/051; B23B 51/08; B23B 51/02

(57) ABSTRACT

A setting tool includes an anchor rod holder (31) open toward a front side of the setting tool, and a drill holder (41) that is open toward a rear side of the setting tool. The setting tool includes a passage (3) through which an anchor rod (10) accommodated in the anchor rod holder (31) may be directly, axially acted on percussively by a drill (20) accommodated in the drill holder (41). Moreover, a fastening arrangement that includes such a setting tool is provided.

The present invention relates to a setting tool, in particular for percussively driving an anchor rod into a substrate. Such a setting tool is equipped with an anchor rod holder that is open toward a front side of the setting tool, and a drill holder that is open toward a rear side of the setting tool. Moreover, the present invention relates to a fastening arrangement that includes such a setting tool.

### BACKGROUND

EP 1281481 A2 describes a setting tool for an anchor bolt, with a hollow shaft for accommodating a drill; a solid shaft for percussively acting on the anchor bolt adjoins the hollow shaft. According to EP 1281481 A2, the setting tool includes a holder for the anchor bolt without a nut, and a second holder for the anchor bolt with a screwed-on nut.

DE 102012221114 B3 describes a setting tool made up of a first part for driving in a drop-in anchor, and a second part, mountable on the first part, for drilling a borehole for the drop-in anchor.

Further setting tools are provided in EP 2754534 A2, US 2015167715 A1, DE 102006000362 A1, EP 1162036 A2, U.S. Pat. No. 6,125,519 A, and U.S. Pat. No. 4,745,831 A.

### SUMMARY OF THE INVENTION

It is an object of the present invention to provide a setting tool for anchor rods, and a fastening arrangement that includes such a setting tool, a particularly efficient pulse transmission to the anchor rod being possible, and particularly good wear resistance being provided, with a particularly simple and cost-effective design and good usability.

The object is achieved according to the present invention by a setting, and a fastening arrangement that includes such a setting tool.

A setting tool according to the present invention is characterized in that it includes a passage through which an anchor rod accommodated in the anchor rod holder may be directly, axially acted on percussively by a drill accommodated in the drill holder.

A core concept of the present invention may be regarded as configuring the setting tool for a direct pulse transmission from the drill to the anchor rod; i.e., the setting tool forms a guide for the drill which directs the tip of the drill directly onto the head of the anchor rod. Accordingly, the present invention is characterized by a passage through which the tip of the drill situated in the drill holder may act directly on the rear end-face side of the anchor rod. A particularly efficient power flow is thus provided in a particularly simple manner, in which the pulses of the drill and of the machine driving the drill may be transmitted to the anchor rod with particularly low loss. In addition, since in the setting tool according to the present invention the drill strikes against a stop surface, namely, the rear end-face side of the anchor rod, that changes with each setting operation, and does not always strike the same intermediate piece, which is the case with a direct power transmission, premature wear on the setting tool or even the drill undesirably working its way into the setting tool is counteracted in a particularly simple manner. Since the head of the anchor rod, i.e., its rear area, is frequently strain-hardened during manufacture of the anchor rod, impairment of the proper functioning of the anchor rod is generally not to be expected.

The anchor rod holder is used for accommodating, preferably axially inserting, an anchor rod, and the drill holder is used for accommodating, preferably axially inserting, a drill.

The setting tool may in particular be used for percussively driving the anchor rod into a borehole. For example, the anchor rod may be part of an expansion anchor, preferably an expansion anchor of the bolt type. An expansion anchor may be characterized in particular in that it includes an expansion element, for example an expansion sleeve, that is pushed radially outwardly by an expansion body situated on the anchor rod when the expansion body is moved axially relative to the expansion element. In particular, the anchor rod may have a male thread.

The anchor rod, which is preferably metallic, may also include a protective cap made of plastic, for example, on its rear end-face side to be acted on by the drill. A diaphragm that is penetrable by the drill may also be situated in the passage of the setting tool.

When reference is made to the axial direction or the radial direction, this may refer in particular to the longitudinal axis of the drill holder, the longitudinal axis of the anchor rod holder, the longitudinal axis of the drill, the longitudinal axis of the anchor rod, and/or a shared longitudinal axis.

The drill may preferably be a masonry drill. The drill may in particular be a twist drill, and/or preferably includes a cylindrical shaft, in particular with at least one helical groove, the shaft being insertable into the drill holder. The drill may advantageously include a hard metal tip.

It is particularly advantageous that the setting tool includes a drill sleeve in which the drill holder is formed. Such a sleeve allows particularly effective guiding of the drill. The drill sleeve, in particular in its front end area, preferably has an inner cross-sectional restriction as an axial stop for the drill accommodated in the drill holder, and/or as a guide for a rear end of the anchor rod. On the one hand, particularly reliable guiding of the anchor rod relative to the drill may thus be achieved in a particularly simple manner in the precise area in which the pulses are transmitted from the drill to the anchor rod, so that the operational reliability may be even further increased. On the other hand, the axial position of the setting tool relative to the drill may thus be defined in a particularly simple manner. The inner cross-sectional restriction may be formed, for example, by one or multiple webs or by a constriction. The inner cross-sectional restriction is apparent in particular in a viewing direction in the axial direction, whereas in other viewing directions a cross-sectional expansion may even be provided. During operation of the setting tool, the tip of the drill may rest, at least temporarily, against the inner cross-sectional restriction. In order for the drill accommodated in the drill holder to be able to directly axially act, according to the present invention, on the anchor rod accommodated in the anchor rod holder, a free remaining cross section is provided in the inner cross-sectional restriction which at least also defines the passage according to the present invention, and via which the drill may act directly on the anchor rod. The inner cross-sectional restriction, in particular on its side facing the drill, may have a rotationally symmetrical design when rotated about an arbitrary angle, so that the drill has no preferred contact point. This may be beneficial for the wear behavior. Alternatively, the inner cross-sectional restriction may also include separate projections that may be used, for example, for particularly effective coupling with the drill and/or the anchor rod.

In another preferred embodiment of the setting tool, the setting tool includes a nut retaining element in which a nut holder for rotatably fixedly accommodating a nut that is screwed onto the anchor rod is formed. Undesirable rotation of the nut, triggered by vibrations of the machine driving the drill, may thus be avoided in a particularly simple manner, and at the same time the guiding of the anchor rod may be even further improved. The nut retaining element may be designed as a grip element and/or may be coupled to a grip element.

For example, the nut holder may have an internal polygonal structure, in particular an internal hexagonal structure. This internal polygonal structure may correspond to an outer contour of the nut, thus form-fittingly securing the nut against rotation. Alternatively or additionally, however, the nut holder may include a friction surface that rotatably fixedly secures the nut via frictional engagement. This friction surface may be situated in particular at the base of the nut holder. Alternatively or additionally, the nut holder may also include elastic parts that adapt to the shape of the nut for rotatably fixedly securing.

The nut holder advantageously includes a base that forms an axial stop for the nut. The axial position of the setting tool relative to the anchor rod may thus be defined in a particularly simple manner. In particular, the anchor rod holder may be formed in the base of the nut holder. For example, the anchor rod holder may be formed by a preferably central borehole in the base of the nut holder. The nut holder advantageously has a cup-shaped design, and/or its base has a ring-shaped design.

In addition, it is advantageous that the nut retaining element and the drill sleeve are fastened so that they are axially displaceable with respect to one another. A particularly robust, and at the same time reliable, setting tool may be obtained in this way. In particular, it may also be ensured that the drill has particularly reliable contact with the anchor rod during the setting operation.

According to another advantageous embodiment, it may be provided that the nut retaining element and the drill sleeve are slidable into one another, in particular axially slidable into one another. A particularly robust, compact, and reliable setting tool may be obtained in this way. In particular, the drill sleeve may be situated inside the nut retaining element. This specific embodiment may be particularly advantageous when the diameter of the nut is larger than the diameter of the drill, which may be the case in particular when the drill and the anchor rod have approximately the same diameter. In particular in this case, this specific embodiment may allow an even more compact, and at the same time robust and reliable, design of the setting tool.

In another preferred embodiment of the present invention, the setting tool includes a bellows that is situated on the one hand on the drill sleeve, in particular on the rear side, and on the other hand is directly or indirectly situated on the nut retaining element, in particular on the front side. A bellows may be understood in particular to mean, as is customary in the field, an elastically folded tube. The bellows preferably encloses the drill sleeve, at least in areas, and/or the bellows may protect the displacement mechanism from outside influences. Due to the elastic design of the bellows, it may be ensured that the nut may be reliably held by the nut retaining element at various positions along the anchor rod. The wall of the bellows may, for example, have a sinusoidal undulating structure, a triangular wave structure, or other types of shapes.

In particular, it may be provided that the bellows is supported on the one hand on the drill sleeve and on the other hand on the nut retaining element, and/or that the bellows forms a compression spring that stores energy when the nut retaining element and the drill sleeve are slid into one another. Accordingly, the bellows may axially press the nut retaining element, in particular the base of the nut holder, against the nut, which may even further increase the operational reliability.

An annular shoulder on which the bellows is supported may preferably be provided on the drill sleeve, preferably in a rear area of the drill sleeve. A particularly robust and reliable setting tool may be obtained in this way. The drill sleeve may also have a multipart design.

In another advantageous refinement of the present invention, the anchor rod holder and the drill holder are coaxially situated. A particularly effective force and/or pulse transmission between the drill and the anchor rod may thus be obtained, since the power flow is transmitted via the center axis of the drill.

Moreover, the present invention relates to a fastening arrangement that includes a setting tool according to the present invention, an anchor rod that is situated in the anchor rod holder of the setting tool, and a drill that is situated in the drill holder of the setting tool. This corresponds to the operationally ready configuration of the setting tool.

In particular, it may be provided that the drill and the anchor rod at least approximately have the same diameter. According to this specific embodiment, the drill, which is used for creating the borehole for the anchor rod, is also used for operating the setting tool for the same anchor rod, which may even further simplify the setting operation.

Features that are explained in conjunction with the fastening arrangement according to the present invention may also be used in the setting tool according to the present invention, and conversely, features that are explained in conjunction with the setting tool according to the present invention may also be used in the fastening arrangement according to the present invention.

The present invention is explained in greater detail below with reference to preferred exemplary embodiments that are schematically illustrated in the appended figures; within the scope of the present invention, individual features of the exemplary embodiments described below may in principle be implemented alone or in any arbitrary combination.

### BRIEF DESCRIPTION OF THE DRAWINGS

FIG. 1 shows a longitudinal sectional view of one specific embodiment of a fastening arrangement according to the present invention together with a setting tool according to the present invention, prior to the setting operation;

FIG. 2 shows the fastening arrangement from FIG. 1 in a longitudinal sectional view, with a deflected bellows and contact between the tip of the drill and the anchor rod during the setting operation; and

FIG. 3 shows a detailed longitudinal sectional view of a fastening arrangement according to the present invention according to a slightly modified further specific embodiment, prior to the setting operation.

### DETAILED DESCRIPTION

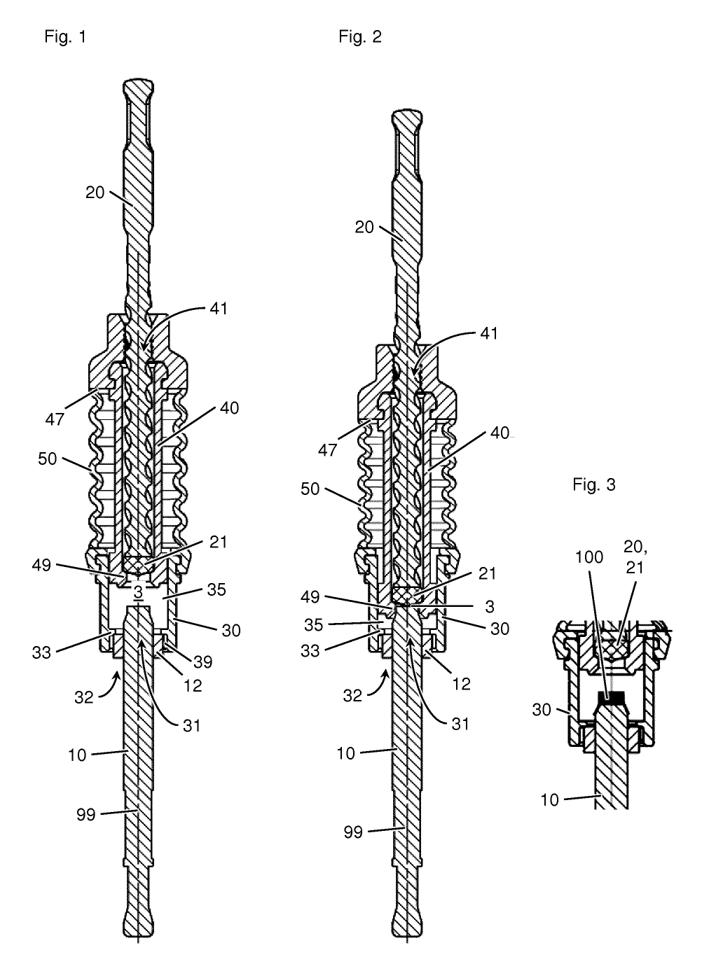

A first exemplary embodiment of a fastening arrangement according to the present invention together with a setting tool according to the present invention is illustrated in FIGS. 1 and 2. The fastening arrangement includes a setting tool, a drill 20 with a tip 21 on the front side, and an anchor rod 10, anchor rod 10 in its rear end area including a nut 12 that is screwed onto anchor rod 10.

The setting tool in its front area includes a nut retaining element 30 designed as a sleeve. A cup-shaped nut holder 32 that is open toward the front, and in which nut 12 situated on anchor rod 10 is rotatably fixedly accommodated, is provided on the front end-face side of nut retaining element 30. Nut holder 32 may have an internal polygonal structure 39, for example, for rotatably fixedly coupling to nut retaining element 30. Toward the rear, cup-shaped nut holder 32 is delimited by a ring-shaped base 33 that forms an axial stop for nut 12. A recess is provided in ring-shaped base 33 which forms an anchor rod holder 31, and through which the rear end of anchor rod 10 that supports nut 12 is inserted into the setting tool. On its rear side opposite from nut holder 32, nut retaining element 30 includes a receiving space 35 that is open toward the rear, as explained in greater detail below.

The setting tool also includes a drill sleeve 40 in which an approximately cylindrical drill holder 41 that is open toward the rear side of the setting tool is formed. Drill 20, designed as a twist drill, is inserted into this drill holder 41. At its front end area, i.e., at its end area facing anchor rod holder 31, drill sleeve 40 has an inner cross-sectional restriction 49 that is ring-shaped, for example. This inner cross-sectional restriction 49 forms an axial stop for drill 20 accommodated in drill holder 41, in particular for tip 21 of the drill, the axial stop limiting a movement of drill 20 relative to drill sleeve 40 toward the front. As is apparent in particular in FIG. 2, inner cross-sectional restriction 49 also forms a guide for the rear end of anchor rod 10 situated in anchor rod holder 31.

Drill 20, drill holder 41, anchor rod 10, and anchor rod holder 31 are coaxially situated and define a shared longitudinal axis 99.

In its front end area, preferably at the level of inner cross-sectional restriction 49, drill sleeve 40 is accommodated in rear receiving space 35 of nut retaining element 30 and is insertable into nut retaining element 30 in a telescoping manner.

The setting tool also includes a bellows 50 that encloses drill sleeve 40 in areas. At its front end, bellows 50 is supported on nut retaining element 30, and at its rear end is supported on an annular shoulder 47 that is axial fixedly situated on drill sleeve 40. Drill holder 41 extends through this annular shoulder 47. In the present exemplary embodiment, the drill sleeve has a multipart design with a front element, having a small outer diameter, which protrudes into receiving space 35, and a rear element, having a large outer diameter, on which annular shoulder 47 is formed. However, a one-part design is also possible. In the present exemplary embodiment, the wall of bellows 50 has a sinusoidal undulating structure in the longitudinal section. However, other wall shapes are also possible.

Receiving space 35 of nut retaining element 30 and inner cross-sectional restriction 49 form a passage 3 through which drill 20, accommodated in drill holder 41, with its front-side tip 21 may act directly axially and percussively on the rear end-face side of the anchor rod situated in anchor rod holder 31.

FIG. 1 shows the state of the setting tool prior to the actual setting operation, but after anchor rod 10 and drill 20 have already been inserted into corresponding holders 31 and 41. In this state, drill 20 is still spaced apart from anchor rod 10. After the state shown in FIG. 1 is assumed, drill 20 is moved axially forward toward the rear end of anchor rod 10 until drill 20 extends through passage 3 and rests against the rear end of anchor rod 10. Drill sleeve 40 is hereby axially pushed into receiving space 35 of nut retaining element 30, axially fixed by nut 12 and base 33, by drill 20 which rests against inner cross-sectional restriction 49, the bellows 50 deflecting radially with storage of energy. The resulting state is shown in FIG. 2. In this state, percussive pulses introduced into drill 20 may be relayed by drill 20 directly to anchor rod 10 resting against drill 20. The percussive pulses may preferably be introduced at the end area of drill 20, for example by a drive, not illustrated, that is situated at the rear end area, i.e., at the end area of drill 20 opposite from tip 21.

Another specific embodiment of a fastening arrangement according to the present invention is shown in FIG. 3. This specific embodiment differs from the specific embodiment discussed above solely in that anchor rod 10 according to FIG. 3 includes an additional protective cap 100 made of plastic, for example, at its rear end area facing drill 20. This protective cap 100 in particular covers the rear end-face side of anchor rod 10 against which drill 20 acts percussively, and thus protects the rear end-face side. The remaining features correspond to the specific embodiment in FIGS. 1 and 2, so that in this regard reference is made to the discussion corresponding thereto.

What is claimed is:

1 to 11. (canceled)

12. A setting tool comprising:
an anchor rod holder open toward a front side of the setting tool; and
a drill holder open toward a rear side of the setting tool,
the setting tool including a passage, an anchor rod accommodated in the anchor rod holder directly and axially actable on percussively via the passage by a drill accommodated in the drill holder.

13. The setting tool as recited in claim 12 wherein the setting tool includes a drill sleeve, the drill holder being formed in the drill sleeve, the drill sleeve having an inner cross-sectional restriction as an axial stop for the drill accommodated in the drill holder or as a guide for a rear end of the anchor rod.

14. The setting tool as recited in claim 12 wherein the setting tool includes a nut retaining element, a nut holder for rotatably fixedly accommodating a nut screwed onto the anchor rod being formed in the retaining element, the nut holder including a base forming an axial stop for the nut, and the anchor rod holder being formed in the base of the nut holder.

15. The setting tool as recited in claim 14 wherein the setting tool includes a drill sleeve, the drill holder being formed in the drill sleeve, the drill sleeve having an inner cross-sectional restriction as an axial stop for the drill accommodated in the drill holder or as a guide for a rear end of the anchor rod, and the nut retaining element and the drill sleeve are fastened axially displaceably with respect to one another.

16. The setting tool as recited claim 14 wherein the setting tool includes a drill sleeve, the drill holder being formed in the drill sleeve, the drill sleeve having an inner cross-sectional restriction as an axial stop for the drill accommodated in the drill holder or as a guide for a rear end of the anchor rod, and the nut retaining element and the drill sleeve are slidable into one another, the drill sleeve being situated inside the nut retaining element.

17. The setting tool as recited in claim 16 wherein the setting tool includes a bellows situated on the drill sleeve as well as on the nut retaining element.

18. The setting tool as recited in claim 17 wherein the bellows is supported on the drill sleeve as well as on the nut retaining element or the bellows forms a compression spring storing energy when the nut retaining element and the drill sleeve are slid into one another.

19. The setting tool as recited in claim 17 wherein the drill sleeve has an annular shoulder, the bellows being supported on the annular shoulder.

20. The setting tool as recited in claim 12 wherein the anchor rod holder and the drill holder are coaxially situated.

21. A fastening arrangement comprising:
the setting tool as recited in claim 12; and
the anchor rod, the anchor rod being situated in the anchor rod holder of the setting tool, and
the drill, the drill being situated in the drill holder of the setting tool.

22. The setting tool as recited in claim 21 wherein the drill and the anchor rod have a similar diameter.
